(19) United States
(12) Patent Application Publication
(10) Pub. No.: US 2015/0040505 A1
(43) Pub. Date: Feb. 12, 2015

(54) PRECAST REINFORCED CONCRETE STRUCTURE AND METHOD FOR FORMING THE SAME

(71) Applicant: Mingjin CHU, Yantai (CN)

(72) Inventor: Mingjin CHU, Yantai (CN)

(21) Appl. No.: 14/525,193

(22) Filed: Oct. 27, 2014

Related U.S. Application Data
(63) Continuation-in-part of application No. PCT/CN2013/074493, filed on Apr. 22, 2013.

(30) Foreign Application Priority Data
Apr. 27, 2012 (CN) 201210126921.3

(51) Int. Cl. E04C 2/06; E04C 5/01; B28B 1/00; E04B 2/86; B28B 1/14; E04C 5/08; E04B 2/84

(52) U.S. Cl. CPC E04C 2/06; E04C 5/08; E04C 5/01; E04B 2/84; E04B 2/8647; B28B 1/14; B28B 1/00
USPC 52/427; 264/219; 264/138

(57) ABSTRACT

A precast reinforced concrete structure including a precast slab. The precast slab includes at least one longitudinal hole and a longitudinal edge. The longitudinal hole is parallel to the surface of the precast slab and is disposed in the vicinity of the longitudinal edge. The longitudinal edge includes a plurality of transverse recesses disposed at intervals, and the transversal recesses intersect with the longitudinal hole.

### CROSS-REFERENCE TO RELATED APPLICATIONS

This application is a continuation-in-part of International Patent Application No. PCT/CN2013/074493 with an international filing date of Apr. 22, 2013, designating the United States, now pending, and further claims priority benefits to Chinese Patent Application No. 201210126921.3 filed Apr. 27, 2012. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to a precast reinforced concrete structure and a method for forming the same.

2. Description of the Related Art

The integrity of the precast concrete structure is determined by mechanical properties of horizontal joints and vertical joints between precast elements, which, conventionally, is primarily dependent on the bonding performance of new concrete and old concrete and the reinforcement passing through the bonding surface.

Two technical routes are generally used to improve the mechanical behavior of the joints. The first technical route is to improve the performance of the concrete bonding surface. The performance of the concrete bonding surface is primarily correlated to the anti-shearing capacity of the interface between the new and old concretes, and measurements including adopting surface chiseling of the precast concrete, arranging stubbles, and reserving sunk keys are generally adopted to increase the bonding strength between the old concrete and the new concrete and to improve the mechanical behavior of the joints. Experiments have demonstrated that these measurements cannot overcome the drawbacks in crack resistance. Because the interface between the old concrete and the new concrete has a lower strength than the body strength of the new concrete or the old concrete, the joint will crack in the presence of a small force, thereby affecting the integrity and the service performance of the structure.

The second technical route is to enhance the reinforcement structure at the joint to improve the ductility and the bearing capacity of the joint. Reinforcing steels for jointing are disposed on the precast member and stretch out from the precast member to a certain length. The reinforcing steels are connected together at the joints. However, the technical route has obvious limitation that the reinforcement at the joint does not obviously improve the crack resistance. It is desired to improve the bonding strength and the crack resistance at the joints between the precast concrete members and to improve the integrity of the structure. Besides, the anchoring reinforcement is extended from one side of the precast member, which results in a plurality of problems during manufacturing, lifting, and transportation. 1) In manufacturing precast concrete member having one side extending the reinforcement, grooving is required at the position of the reinforcement on the mold plate, and foamed plastics and small molds are disposed at the groove so as to prevent the concrete from leaking out or affecting the production efficiency. When the precast concrete member comprises two or more than two reinforcements arranged in parallel, it is difficult to conduct the grooving of the mold plates between the parallel reinforcement and the concrete easily leaks out, which affects the quality of the precast member. 2) The reinforcement extended from the precast member disturbs the transportation, lifting, and location of the members.

### SUMMARY OF THE INVENTION

In view of the above-described problems, it is one objective of the invention to provide a precast reinforced concrete structure and a method for forming the same. The precast reinforced concrete structure should be mass producible and have low production cost, stable seam performance, and high building performance.

To achieve the above objective, in accordance with one embodiment of the invention, there is provided a precast reinforced concrete structure, the structure comprising a precast slab, the precast slab comprising at least one longitudinal hole and a longitudinal edge. The longitudinal hole is parallel to a surface of the precast slab and is disposed in the vicinity of the longitudinal edge. The longitudinal edge comprises a plurality of transverse recesses disposed at intervals, and the transversal recesses intersect with the longitudinal hole. The end of the transverse recesses is located in the longitudinal hole, or extends to the concrete at the inner side of the longitudinal hole. The transverse recesses intersect with one or more of the longitudinal holes. The longitudinal holes are through holes or blind holes, and round holes, rounded rectangular holes, or polygonal holes in shape, and so on. A side view of the transverse recesses is in the shape of a trapezoid, rectangle, or semicircle, and so on. At least one longitudinal hole is disposed in the precast reinforced concrete structure and intersects with the transverse recesses at the edge thereof.

In a class of this embodiment, the precast reinforced concrete structure is a flat slab, T-shaped wall, L-shaped wall, cross-shaped wall, or a wall comprising a cavity. The wall comprising the cavity further comprises an upper connection beam of the cavity, and two side walls surrounding the cavity. The precast reinforced concrete structure can also comprise a side column.

In a class of this embodiment, the longitudinal edge of the precast slab comprises a plurality of transverse recesses at intervals. Thus, the longitudinal edge presents a tooth-like structure. The transverse recesses and the protrusions are disposed alternately. To save the formwork consumption, a concrete plate is disposed at one side of the transverse recesses so that one side of the longitudinal edge is in the shape of a dentation, and the other side is linear. The surrounding edge of the transverse recesses is oblique or vertical to the longitudinal edge. The transverse recesses at two longitudinal edges of the precast reinforced concrete structure are disposed in the same horizontal line, or staggered, that is to say, one longitudinal edge of the precast reinforced concrete structure is provided with the transverse recesses, the other longitudinal edge of the precast reinforced concrete structure is provided with the protrusions at the corresponding positions.

In a class of this embodiment, the precast reinforced concrete comprises a reinforcing cage comprising longitudinal ribs, transverse ribs, and stirrups.

In a class of this embodiment, the precast reinforced concrete structure comprises a transverse blind hole. The ends of the transverse blind hole communicate with the longitudinal holes.

The precast reinforced concrete structure can be applied to irregular walls comprising an arc or/and folded corners, to load-bearing walls, and to shear walls, and so on.

In accordance with another embodiment of the invention, there provided is a method for forming a precast reinforced concrete structure, the method comprising:
1) providing bottom formworks, a first top formwork, a second top formwork, side formworks, and a plurality of steel tube formworks for preparing longitudinal holes on a construction site of a precast slab, wherein the side formworks comprise a plurality of transverse recesses at intervals, and the first and second top formworks each comprise a plurality of holes having a shape and size corresponding to that of the steel tube formworks;
2) combining the bottom formworks, the first and second top formworks, and the side formworks, disposing a reinforcing mesh in a space formed by the formworks, allowing a plurality of steel tubes to insert into the holes of the first top formwork, through the reinforcing mesh, and reach the holes of the second top formwork, wherein ends of the transverse recesses of the side formworks are closely attached to an outermost steel tube inserted in the holes of the first and second top formworks;
3) pouring concrete in the space formed by the bottom formworks, the first and second top formworks, and the side formworks, and drawing out the steel tubes before the concrete gets hardening whereby forming longitudinal holes; and
4) demolishing the bottom formworks, the first and second top formworks, and the side formworks after the concrete reaches a required strength.

Optionally, the invention further provides a method for forming a precast reinforced concrete structure, the method comprising:
1) manufacturing a precast slab comprising longitudinal holes according to a prior precast slab production process; and
2) slitting a longitudinal edge of the precast slab using a slitting saw to form recesses, the recesses intersecting with at least one longitudinal hole, whereby yielding a precast reinforced concrete structure comprising the recesses.

Advantages of the invention are summarized as follows.
1) The precast reinforced concrete structure has high quality, and the method for manufacturing the same has high production efficiency and consumes little resources, which is conducive to sustainable development.
2) The precast reinforced concrete structure has high degree of standardization, which can be used for construction of L-shaped walls, T-shaped walls, cross-shaped walls, walls having a cavity, and so on.
3) The precast reinforced concrete structure is convenient for transportation and assembly. The precast reinforced concrete structure comprises a plurality of holes, so it is light in weight.
4) The joint connection of the precast reinforced concrete structure is stable and reliable. When concrete is pouring, it penetrates into the longitudinal holes and is integrated with the concrete penetrating into the transverse recesses and between two precast reinforced concrete structures, which ensures the tight bonding of the joints of the precast concrete and post-cast concrete. The precast concrete and post-cast concrete are bonded by interlocking, which can produce mechanical stress therebetween thereby improving the crack resistance. For conventional precast reinforced concrete structures, when the joint connection is destroyed, the breaking section mainly occurs at the bonding surface between the earlier poured concrete and later poured concrete. However, in this invention, the breaking section mainly occurs in the later poured concrete in the transverse recesses or in the precast concrete of the protrusions between the transverse recesses. Thus, the jointing mechanism of the precast reinforced concrete structures are totally different from that in the prior art, thereby greatly improving the mechanical properties of the joints.
5) The reinforcing steel is used for the joint connection of adjacent precast reinforced concrete structures. The reinforcing steel is disposed in the transverse recesses on the construction site and does not protrude therefrom. When the concrete is poured, it enters the longitudinal holes; the concrete in the transverse recesses forms a first beam-like structure. Thus, the later poured concrete in the transverse recesses and the later poured concrete in the protrusions form an integrated structure, something like a small continuous beam for connecting and supporting the transverse recesses. The reinforcing steel is fixed in the small beams thereby improving the anchorage performance thereof. The reinforcing steel is mainly disposed in the transverse recesses, so that the space between adjacent precast reinforced concrete structures is shortened, thereby saving the formwork involvement and the material consumption.

### BRIEF DESCRIPTION OF THE DRAWINGS

FIG. 1 is a schematic diagram of a precast reinforced concrete structure in accordance with one embodiment of the invention;

FIG. 2-1 is a sectional view taken from line A-A which shows a protrusion in FIG. 1, and FIG. 2-2 is a sectional view taken from line B-B which shows a transverse recess in FIG. 1;

FIG. 3 is an exploded view of formworks for manufacturing a precast reinforced concrete structure in accordance with one embodiment of the invention;

FIG. 4 is a schematic diagram of a precast reinforced concrete structure having a concrete plate at one side of transverse recesses in accordance with one embodiment of the invention;

FIG. 5-1 is a sectional view taken from line C-C which shows a protrusion in FIG. 4, and FIG. 5-2 is a sectional view taken from line D-D which shows a transverse recess in FIG. 4;

FIG. 6 is a schematic diagram of a precast reinforced concrete structure comprising staggered transverse recesses in accordance with one embodiment of the invention;

FIG. 7-1 is a sectional view taken from line E-E which shows a protrusion in FIG. 6, and FIG. 7-2 is a sectional view taken from line F-F which shows a transverse recess in FIG. 6;

FIG. 8 is a schematic diagram of a precast reinforced concrete structure being a T-shaped wall in accordance with one embodiment of the invention;

FIG. 9 is an exploded view of formworks for manufacturing a precast reinforced concrete structure being a T-shaped wall in accordance with one embodiment of the invention;

FIG. 10 is a schematic diagram of a precast reinforced concrete structure being an L-shaped wall in accordance with one embodiment of the invention;

FIG. 11 is a schematic diagram of a precast reinforced concrete structure being a cross-shaped wall in accordance with one embodiment of the invention;

FIG. 12 is a schematic diagram of a precast reinforced concrete structure comprising a cavity in accordance with one embodiment of the invention;

FIG. 13 is a schematic diagram of a precast reinforced concrete structure comprising a side column in accordance with one embodiment of the invention;

FIG. 14 is a schematic diagram of a precast reinforced concrete structure being a beam in accordance with one embodiment of the invention; and

FIG. 15 is a schematic diagram of a precast reinforced concrete structure being a beam support in accordance with one embodiment of the invention.

### DETAILED DESCRIPTION OF THE EMBODIMENTS

For further illustrating the invention, experiments detailing a precast reinforced concrete structure and a method for forming the same are described below. It should be noted that the following examples are intended to describe and not to limit the invention.

### Example 1

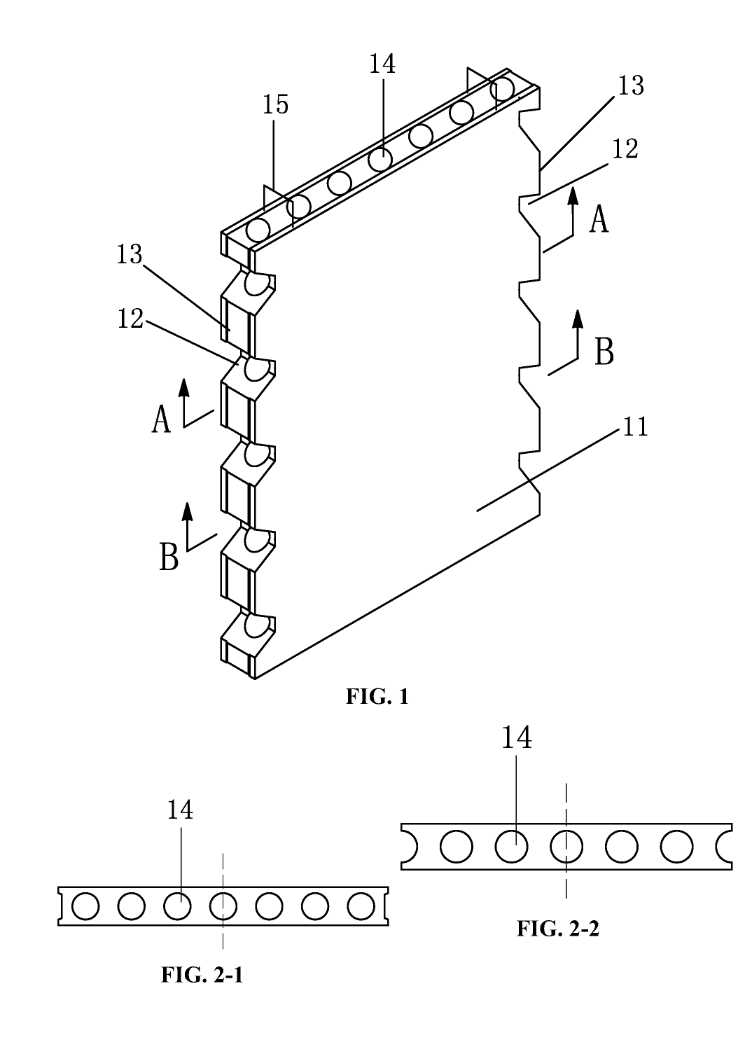

As shown in FIGS. 1, 2-1, and 2-2, a flat slab 11 of a precast reinforced concrete comprises longitudinal edges comprising transverse recesses 12 and protrusions 13 that are disposed alternately. The side view of the transverse recesses 12 is in the shape of a trapezoid. The flat slab comprises a plurality of longitudinal holes 14. The longitudinal holes in the vicinity of the edge intersect with the transverse recesses 12. The flat slab 11 comprises a hanging ring 15 for mounting. When the flat slab is employed as a wall, the length thereof is basically equal to the height of the building, the width is often represented by the construction module of 300, and the thickness is equal to that of the wall.

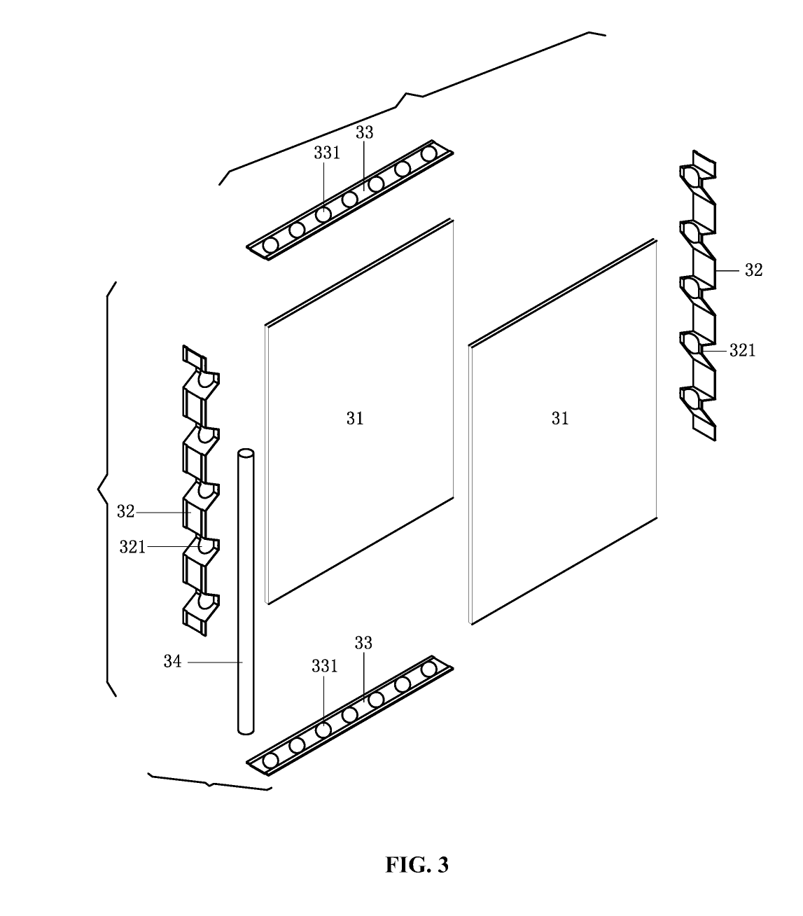

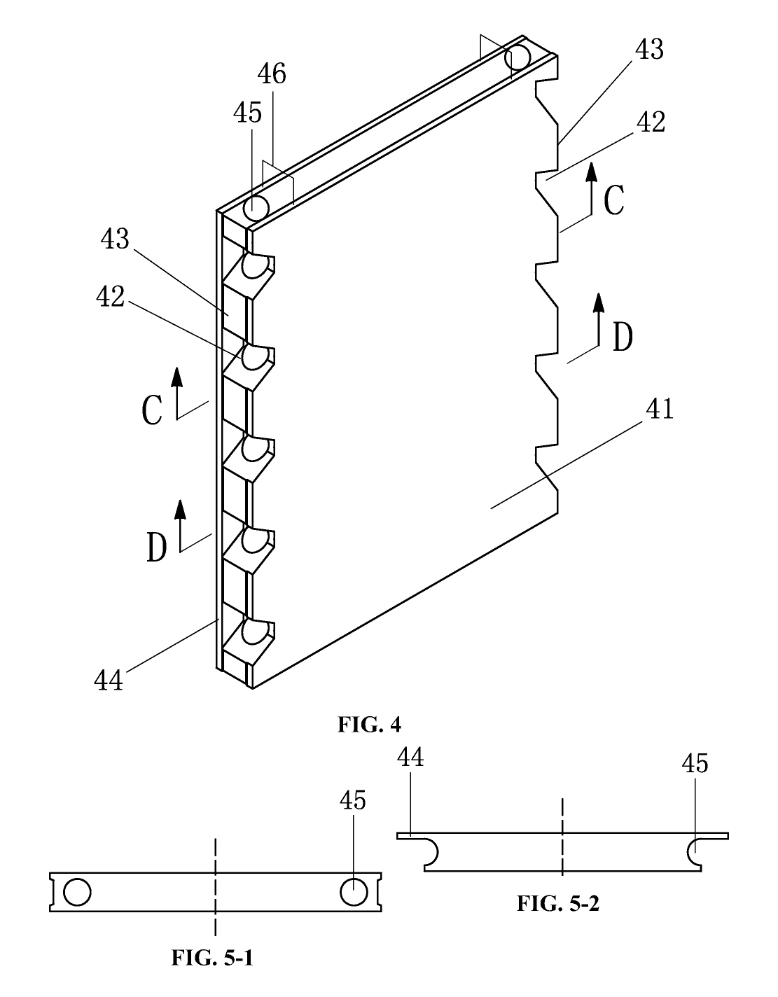

As shown in FIG. 3, the flat slab is prepared as follows:
1) Providing bottom formworks 31, two side formworks 32, a first top formwork 33, a second top formwork 33 on a construction site of a precast slab, and disposing a reinforcing cage in a space formed by the formworks and the hanging ring 15. The side formworks 32 comprise a plurality of transverse recesses at intervals, and the ends 321 of the transverse recesses of the side formworks are closely attached to a steel tube formwork 34 inserted in the holes of the first and second top formworks.
2) Allowing a plurality of steel tube formworks 34 to insert into the holes 331 of the first top formwork, through the reinforcing mesh, and reach the holes 331 of the second top formwork. The outer diameter of the steel tube formworks 34 is the same as that of the holes.
3) Pouring concrete in the space formed by the bottom formworks, the first and second top formworks, and the side formworks, and drawing out the steel tube formworks 34 before the concrete gets hardening whereby forming longitudinal holes 14; and demolishing the bottom formworks 31, the first and second top formworks 33, and the side formworks 32 after the concrete reaches a required strength, whereby yielding a precast reinforced concrete structure comprising the recesses.

The precast reinforced concrete structure comprising the recesses can also be prepared as follows. First, a precast slab comprising longitudinal holes is manufactured according to a prior precast slab production process, and then, a longitudinal edge of the precast slab is slitted using a slitting saw to form recesses, the recesses intersecting with at least one longitudinal hole, whereby yielding a precast reinforced concrete structure comprising the recesses.

Based on the above method, a precast reinforced concrete structure comprising concrete at the side of the recesses can also be made. As shown in FIGS. 4, 5-1, and 5-2, a flat slab 41 of a precast reinforced concrete comprises longitudinal edges comprising transverse recesses 42 and protrusions 43 that are disposed alternately. A concrete plate 44 is disposed at the side of the recesses. The flat slab comprises a plurality of longitudinal holes 45. The longitudinal holes in the vicinity of the edge intersect with the transverse recesses 42. The flat slab 41 comprises a hanging ring 46 for mounting.

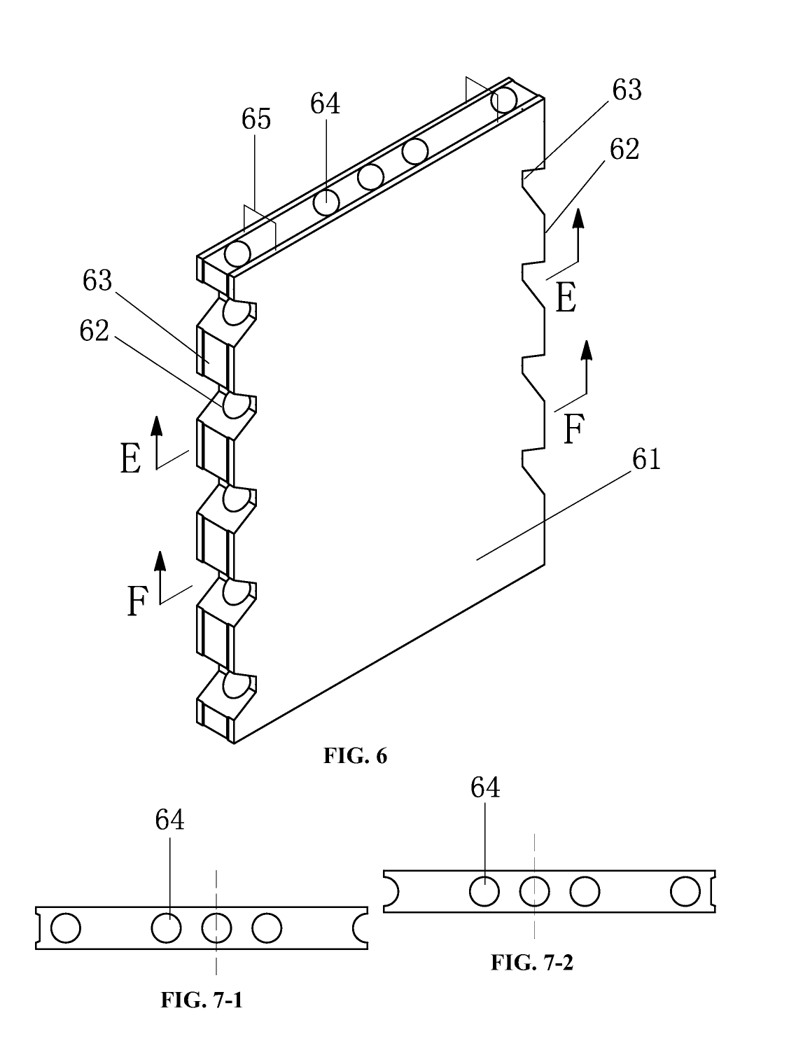

Based on the above method, a precast reinforced concrete structure comprising staggered recesses at two side walls can also be made. As shown in FIGS. 6, 7-1, and 7-2, each side of a flat slab 61 of a precast reinforced concrete comprises longitudinal edges comprising transverse recesses 62 and protrusions 63 that are disposed alternately. The transverse recesses on both sides of the flat slab are staggered. That is to say, when one longitudinal edge the flat slab is provided with a recess 62, the other longitudinal edge corresponding to the longitudinal edge is provided with a protrusion 63. The flat slab 61 comprises a plurality of longitudinal holes 64. The longitudinal holes in the vicinity of the edge intersect with the transverse recesses 62. The flat slab 61 comprises a hanging ring 65 for mounting.

### Example 2

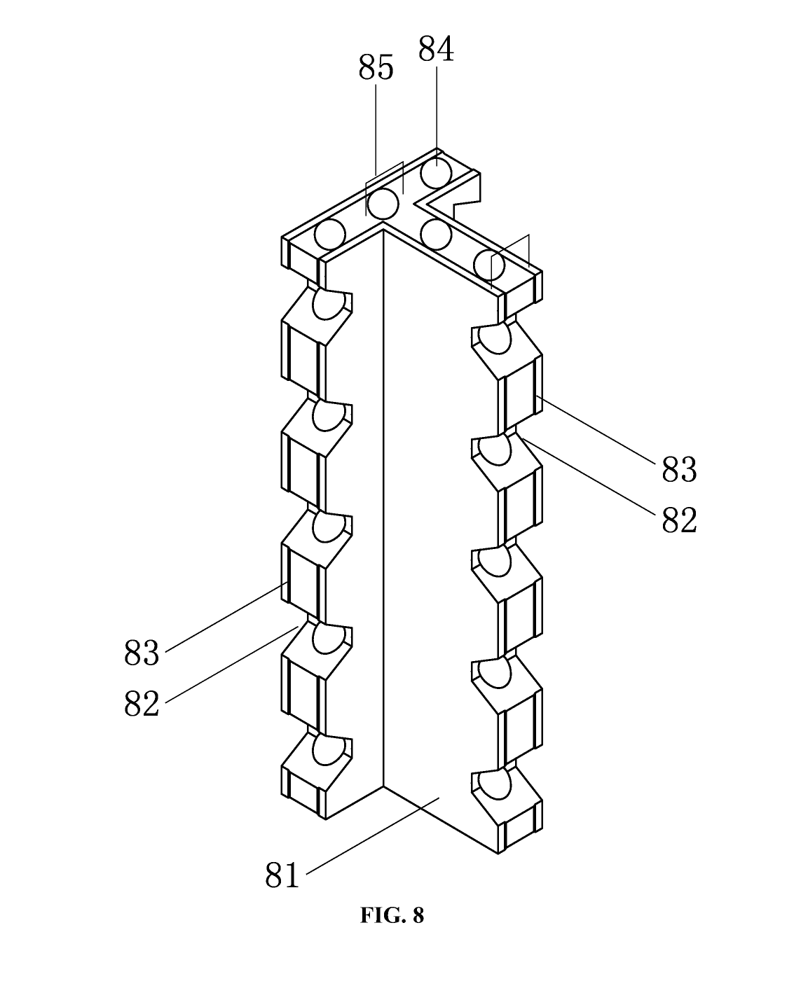

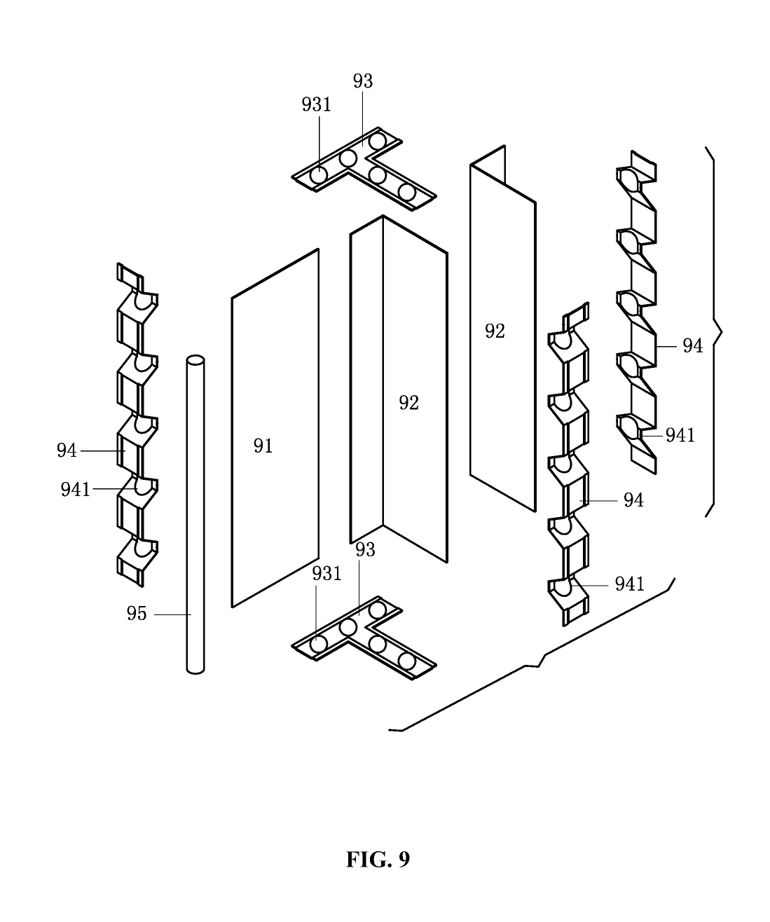

As shown in FIG. 8, a T-shaped precast reinforced concrete 81 is provided. At least one longitudinal edge of T-shaped precast reinforced concrete comprises transverse recesses 82 and protrusions 83 that are disposed alternately. The T-shaped precast reinforced concrete 81 comprises a plurality of longitudinal holes 84. The longitudinal holes in the vicinity of the edge intersect with the transverse recesses 82. The T-shaped precast reinforced concrete 81 comprises a hanging ring 85 for mounting. In practice, the three limbs of the T-shaped precast reinforced concrete have a length that meets the construction requirement. The length of the T-shaped precast reinforced concrete is basically equal to that of the building, and the thickness is equal to that of the wall.

The T-shaped precast reinforced concrete is prepared as follows:
1) Providing a flat formwork 91, two L-shaped formworks 92, a first top formwork 93, a second top formwork 93, and three side formworks 94 on a construction site of a precast slab, and disposing a reinforcing cage in a space formed by the formworks and the hanging ring 85. The reinforcing cage comprises longitudinal ribs and stirrups. The side formworks 94 comprise a plurality of transverse recesses at intervals, and the ends 941 of the transverse recesses of the side formworks are closely attached to a steel tube formwork 95 inserted in the holes of the first and second top formworks.
2) Allowing a plurality of steel tube formworks 95 to insert into the holes 931 of the first top formwork, through the reinforcing mesh, and reach the holes 931 of the second top formwork. The outer diameter of the steel tube formworks 95 is the same as that of the holes 931.
3) Pouring concrete in the space formed by the bottom formworks, the first and second top formworks, and the side formworks, and drawing out the steel tube formworks 95 before the concrete gets hardening whereby forming longitudinal holes 84; and demolishing the flat formwork 91, two L-shaped formworks 92, the first top formwork 93, the second top formwork 93, and the three side formworks 94 after the concrete reaches a required strength, whereby yielding a T-shaped precast reinforced concrete comprising the recesses.

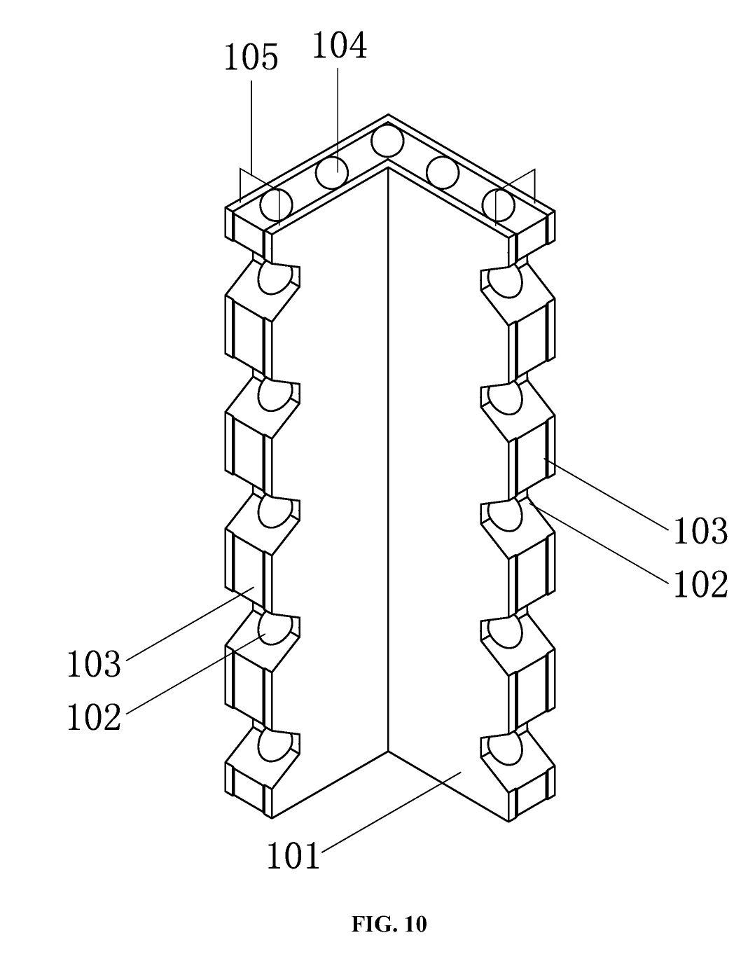

Based on the above method, an L-shaped or cross shaped precast reinforced concrete can also be made. An L-shaped or cross shaped precast reinforced concrete is as shown in FIG. 10. At least one longitudinal edge of the L-shaped precast reinforced concrete 101 comprises transverse recesses 102 and protrusions 103 that are disposed alternately. The L-shaped precast reinforced concrete 101 comprises a plurality of longitudinal holes 104. The longitudinal holes in the vicinity of the edge intersect with the transverse recesses 102. The L-shaped precast reinforced concrete 101 comprises a hanging ring 105 for mounting. In practice, the two limbs of the L-shaped precast reinforced concrete have a length that meets the construction requirement. The length of the T-shaped precast reinforced concrete is basically equal to that of the building, and the thickness thereof is equal to that of the wall.

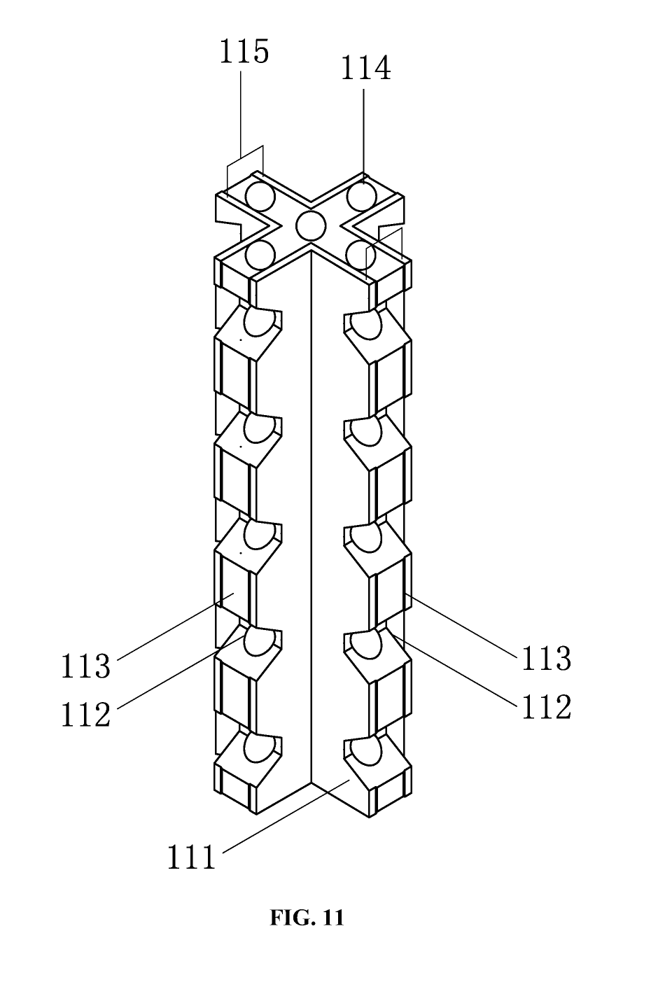

A cross shaped precast reinforced concrete is as shown in FIG. 11. At least one longitudinal edge of the cross-shaped precast reinforced concrete 111 comprises transverse recesses 112 and protrusions 113 that are disposed alternately. The cross shaped precast reinforced concrete 111 comprises a plurality of longitudinal holes 114. The longitudinal holes in the vicinity of the edge intersect with the transverse recesses 112. The cross shaped precast reinforced concrete 111 comprises a hanging ring 115 for mounting. In practice, the four limbs of the cross shaped precast reinforced concrete have a length that meets the construction requirement. The length of the cross shaped precast reinforced concrete is basically equal to that of the building, and the thickness thereof is equal to that of the wall.

Based on the above method, an L-shaped, T-shaped, or cross shaped precast reinforced concrete comprising a concrete plate disposed at the side of the recesses can also be made. Similarly, an L-shaped, T-shaped, or cross shaped precast reinforced concrete structure comprising staggered recesses at two side walls can also be made.

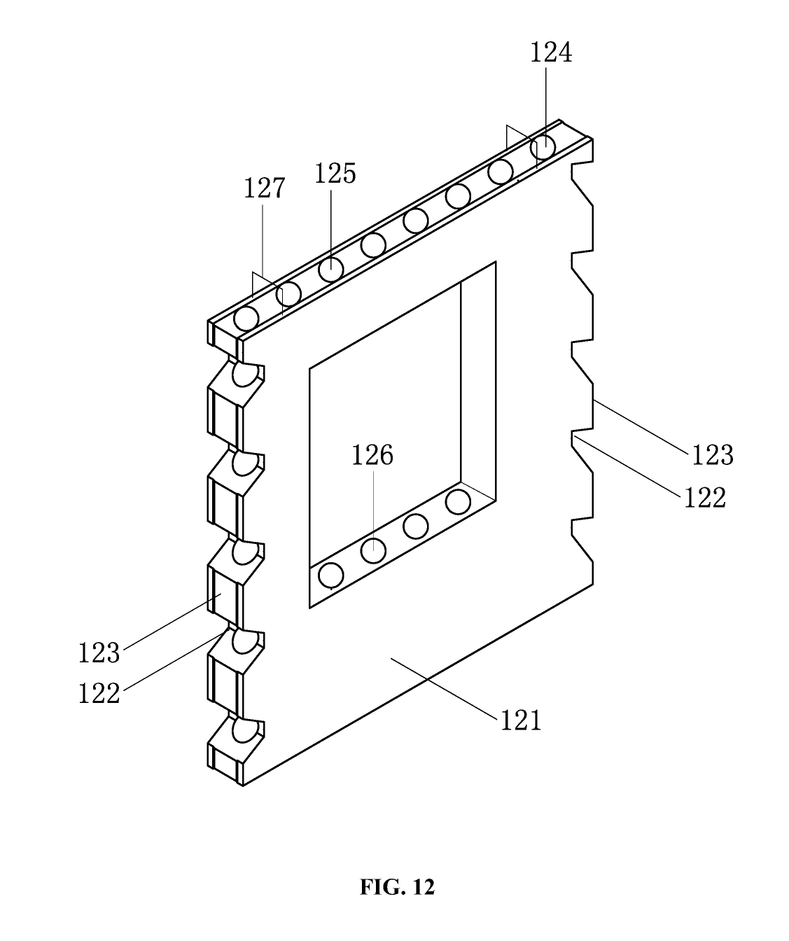

As shown in FIG. 12, a precast reinforced concrete 121 comprising a cavity is provided. The longitudinal edge of the precast reinforced concrete 121 comprising the cavity comprises transverse recesses 122 and protrusions 123 that are disposed alternately. The precast reinforced concrete 121 comprises a plurality of longitudinal holes 124. The longitudinal holes in the vicinity of the edge intersect with the transverse recesses 122. The connection beam above the cavity comprises a plurality of longitudinal blind holes 125, and the distance between the bottom of the blind holes and the surface of the connection beam is greater than or equal to 20 mm. The wall below the cavity (if a door is disposed on the wall, the wall below the cavity is absent) comprises a plurality of longitudinal holes 126. The precast reinforced concrete 121 comprising the cavity comprises a hanging ring 127 for mounting.

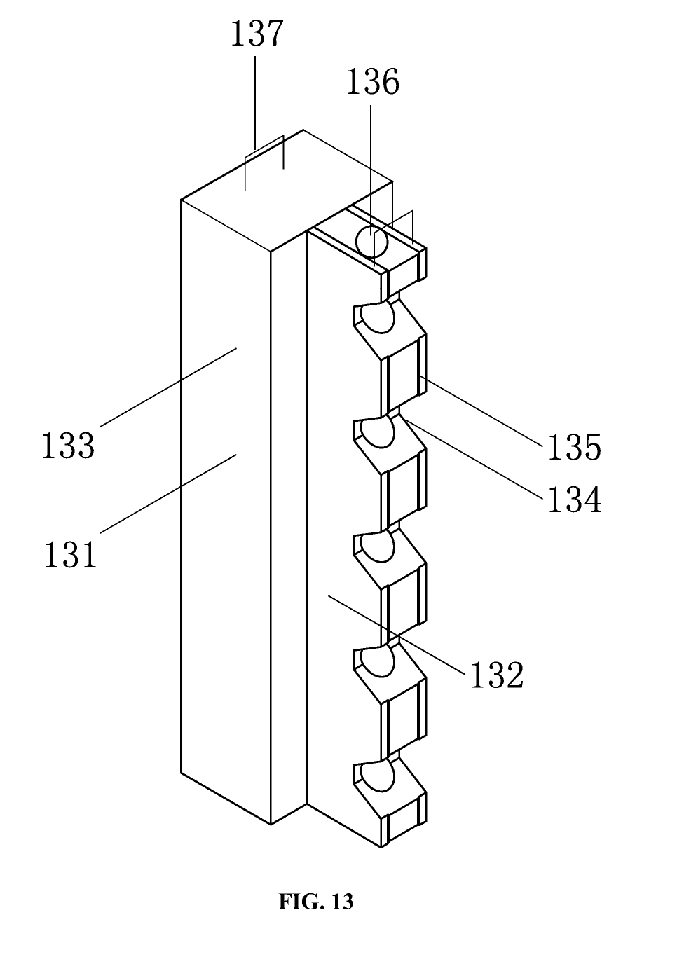

As shown in FIG. 13, a precast reinforced concrete 131 comprising a precast wall plate 132 and a side column 133 is provided. The longitudinal edge of the precast wall plate 132 comprises transverse recesses 134 and protrusions 135 that are disposed alternately. The precast wall plate 132 comprises a plurality of longitudinal holes 136. The longitudinal holes in the vicinity of the edge intersect with the transverse recesses 134. The precast reinforced concrete 131 comprising the precast wall plate 132 and the side column 133 comprises a hanging ring 137 for mounting.

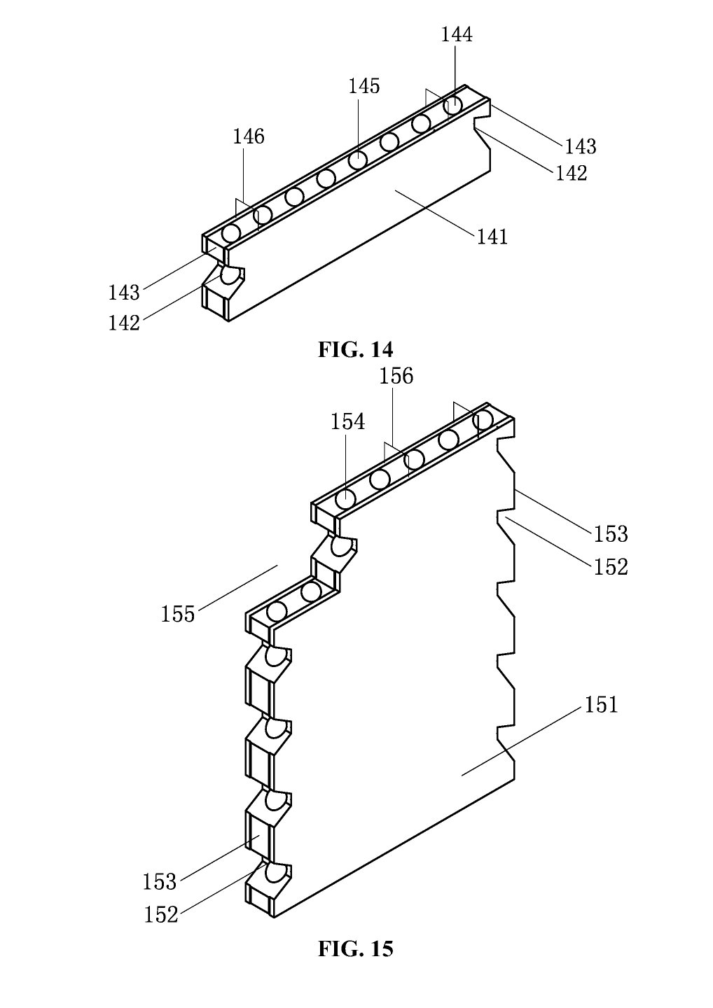

As shown in FIG. 14, a precast reinforced concrete beam 141 is provided. The ends of the precast reinforced concrete beam 141 comprise transverse recesses 142 and protrusions 143 that are disposed alternately. The ends of the precast reinforced concrete beam 141 comprise a plurality of longitudinal holes 144. The longitudinal holes in the vicinity of the edge intersect with the transverse recesses 142. The middle of the precast reinforced concrete beam 141 comprises a plurality of longitudinal blind holes 145, and the distance between the bottom of the blind holes and the surface of the beam is greater than or equal to 20 mm. The precast reinforced concrete beam 141 comprises a hanging ring 146 for mounting.

As shown in FIG. 15, a precast reinforced concrete 151 of a supporting base of a beam is provided. The longitudinal edge of the precast reinforced concrete 151 comprises transverse recesses 152 and protrusions 153 that are disposed alternately. The precast reinforced concrete 151 comprises a plurality of longitudinal holes 154. The longitudinal holes in the vicinity of the edge intersect with the transverse recesses 152. The precast reinforced concrete 151 is narrowed inwards at the support base of the beam (as shown by 155). The precast reinforced concrete 151 comprises a hanging ring 156 for mounting.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A precast reinforced concrete structure, the structure comprising a precast slab, the precast slab comprising at least one longitudinal hole and a longitudinal edge, wherein the longitudinal hole is parallel to a surface of the precast slab and is disposed in the vicinity of the longitudinal edge, the longitudinal edge comprises a plurality of transverse recesses disposed at intervals, and the transversal recesses intersect with the longitudinal hole.

2. A structure of claim 1, wherein the precast slab comprises a plurality of longitudinal holes which are parallel to one another, and the transversal recesses intersect with the longitudinal hole in the vicinity of the longitudinal edge.

3. The structure of claim 1, wherein the precast slab is a flat slab configured to form a wall, a roof layer, or a floor layer, and the flat slab comprises a framework of steel reinforcement comprising a plurality of transverse stirrups.

4. The structure of claim 1, wherein the precast slab is configured to form a T-shaped, L-shaped, or cross-shaped column wall, and the precast slab comprises a framework of steel reinforcement comprising a plurality of transverse stirrups.

5. The structure of claim 1, wherein the precast slab is configured to form a wall having a cavity, and the wall having the cavity also comprises an upper connection beam of the cavity, and two side walls surrounding the cavity.

6. The structure of claim 1, wherein the longitudinal holes are round holes, rounded rectangular holes, or polygonal holes.

7. The structure of claim 1, wherein a concrete plate is disposed at one side of the transverse recesses.

8. The structure of claim 2, wherein a concrete plate is disposed at one side of the transverse recesses.

9. The structure of claim 3, wherein a concrete plate is disposed at one side of the transverse recesses.

10. The structure of claim 4, wherein a concrete plate is disposed at one side of the transverse recesses.

11. The structure of claim 1, wherein the transversal recesses at two longitudinal edges of the precast slab are staggered.

12. The structure of claim 2, wherein the transversal recesses at two longitudinal edges of the precast slab are staggered.

13. The structure of claim 3, wherein the transversal recesses at two longitudinal edges of the precast slab are staggered.

14. The structure of claim 4, wherein the transversal recesses at two longitudinal edges of the precast slab are staggered.

15. The structure of claim 1, wherein the precast slab comprises a transverse blind hole.

16. The structure of claim 2, wherein the precast slab comprises a transverse blind hole.

17. The structure of claim 3, wherein the precast slab comprises a transverse blind hole.

18. The structure of claim 4, wherein the precast slab comprises a transverse blind hole.

19. A method for forming a precast reinforced concrete structure, the method comprising:
1) providing bottom formworks, a first top formwork, a second top formwork, side formworks, and a plurality of steel tube formworks for preparing longitudinal holes on a construction site of a precast slab, wherein the side formworks comprise a plurality of transverse recesses at intervals, and the first and second top formworks each comprise a plurality of holes having a shape and size corresponding to that of the steel tube formworks;
2) combining the bottom formworks, the first and second top formworks, and the side formworks, disposing a reinforcing mesh in a space formed by the formworks, allowing a plurality of steel tubes to insert into the holes of the first top formwork, through the reinforcing mesh, and reach the holes of the second top formwork, wherein ends of the transverse recesses of the side formworks are closely attached to an outermost steel tube inserted in the holes of the first and second top formworks;
3) pouring concrete in the space formed by the bottom formworks, the first and second top formworks, and the side formworks, and drawing out the steel tubes before the concrete gets hardening whereby forming longitudinal holes; and
4) demolishing the bottom formworks, the first and second top formworks, and the side formworks after the concrete reaches a required strength.

20. A method for forming a precast reinforced concrete structure, the method comprising:
1) manufacturing a precast slab comprising longitudinal holes according to a prior precast slab production process; and
2) slitting a longitudinal edge of the precast slab using a slitting saw to form recesses, the recesses intersecting with at least one longitudinal hole, whereby yielding a precast reinforced concrete structure comprising the recesses.
